(19) United States
(12) Patent Application Publication
(10) Pub. No.: US 2025/0313470 A1
(43) Pub. Date: Oct. 9, 2025

(54) NITROUS ACID MEASUREMENT BY CATALYTIC CONVERSION TO NITRIC OXIDE ON SULFONATED TETRAFLUOROETHYLENE -BASED FLUOROPOLYMER-COPOLYMER SURFACES

(71) Applicant: THE TRUSTEES OF INDIANA UNIVERSITY, Bloomington, IN (US)

(72) Inventors: Jonathan Daniel RAFF, Bloomington, IN (US); Zachary Coffman PAYNE, Bloomington, IN (US); Evan Zachary DALTON, Bloomington, IN (US)

(21) Appl. No.: 18/865,018

(22) PCT Filed: May 23, 2023
(86) PCT No.: PCT/US2023/023259

§ 371 Date: Nov. 12, 2024

Related U.S. Application Data
(60) Provisional application No. 63/345,201, filed on May 24, 2022.

(51) Int. Cl. C01B 21/24; F01N 3/20

(52) U.S. Cl. CPC C01B 21/24; F01N 3/20

(57) ABSTRACT

The present disclosure relates to a system adapted to convert gaseous nitrous acid into gaseous nitric oxide. The system includes a catalytic converter and a nitric oxide analyzer. The catalytic converter includes a polytetrafluoroethylene tube and one or more concentric tubes or high surface substrates made of sulfonated tetrafluoroethylene-based fluoropolymer-copolymer positioned within the polytetrafluoroethylene tube.

### PRIORITY CLAIM

This application claims priority under 35 U.S.C. § 119(e) to U.S. Provisional Application No. 63/345,201, filed May 24, 2022, which is expressly incorporated by reference herein in its entirety.

### GOVERNMENT SUPPORT CLAUSE

This invention was made with government support under DE-SC0014443 awarded by the U.S. Department of Energy, and AGS1352375 awarded by the National Science Foundation. The government has certain rights in the invention.

### BACKGROUND

The present disclosure relates generally to catalytic converters. More specifically, the present disclosure relates to catalytic converters which convert gaseous nitrous acid (HONO) into gaseous nitric oxide (NO).

Nitrous acid (HONO) is a photochemical precursor to nitric oxide (NO) and hydroxyl radical (OH) that regulate the oxidative capacity of the lower troposphere. Concentrations of HONO in urban environments range from 0.1-10 parts-per-billion (ppb); in regions that experience less anthropogenic influence, concentrations range from 10-100 parts-per-trillion (ppt). In most environments, the rate of HONO formation is higher than expected from the gas phase reaction of NO and OH, suggesting there are missing sources of HONO. Proposed sources include heterogeneous reactions of nitrogen dioxide (NO₂) on boundary layer surfaces, nitrate photochemistry, or the protonation of soil nitrite (NO₂⁻). Direct emissions stem from fossil fuel combustion, biomass burning, and from the activity of nitrifying and denitrifying soil microbes. HONO is notoriously reactive on surfaces and its chemistry is intimately related to other nitrogen oxides and reactive intermediates, which complicate its detection. Quantifying HONO in ambient air in the presence of other nitrogen oxides requires a detection method that is both sensitive and selective for HONO.

Analytical methods designed to measure HONO are based on absorption spectroscopy, mass spectrometry, wet chemical techniques, or chemiluminescence detection. Direct absorption measurements such as differential optical absorption spectroscopy (DOAS) and incoherent broadband cavity enhanced absorption spectroscopy (IBB-CEAS) provide direct unambiguous quantification of HONO without need for calibration with limits of detection (LOD) of 0.02-2 ppb; however, they are complex systems that are not available commercially. Negative ion proton transfer chemical ion mass spectrometry (NI-PTR-CIMS) has also been employed using the reagent ions SF₆⁻, I⁻, or CH₃COO⁻ to convert HONO into NO₂⁻. These techniques are selective to specific target ions and sensitive (LOD=5-10 ppt), but need to be regularly calibrated, and can suffer from interferences related to water clustering and competing ions of similar mass. One method to measure HONO is via long path absorption photometry (LOPAP), which is a selective wet chemical method that involves converting HONO into a colored azo dye by reaction with N-(1-naphthyl)ethylendiamine-dihydrochloride, followed by detection using a long path absorption in a liquid core waveguide. While this instrument is very sensitive (LOD<50 ppt), it is specific to measuring HONO, necessitating the use of other instrumentation to quantify other reactive nitrogen species.

Because HONO, NO₂, and NO chemistry are interconnected by a complex network of reactions, there is a need to develop a sensitive technique to measure all three gases without interference. One method uses chemiluminescence (CL) detection of NO. The technique is based on the reaction between NO and O₃, which produces electronically excited NO₂ (NO₂*) that relaxes to emit photons that are proportional to the initial NO concentration. Measurement of NO₂ is achieved indirectly by first converting it to NO, either with a heated molybdenum catalyst or through photodissociation. These systems have been modified to measure HONO either by the introduction of a denuder capable of removing HONO (e.g., sodium bicarbonate) or by using a second photolytic converter at a different wavelength to differentiate between NO₂ and HONO. Unfortunately, these methods suffer from interferences with other species that form NO (molybdenum converter and denuder) or have relatively low conversion efficiencies (photolytic converter), which limits their use. In the case of denuders, bicarbonate must be replaced frequently and the HONO removal efficiency changes over time, requiring frequent redetermination.

Therefore, a robust and inexpensive detection method based on CL that allows selective conversion of HONO into NO at efficiencies that are above what is possible using photodissociation (7-14%) is desired. Such a converter enables measurement of atmospherically relevant concentrations (<1 ppb) of HONO, NO, and NO₂ using a single CL system and would not need to be exchanged or calibrated over the course of a measurement campaign. During studies to determine inlet losses of HONO with the present CL system, it was found that HONO was being converted to NO on a sulfonated tetrafluoroethylene-based fluoropolymer-copolymer (e.g. Nafion™) dryer used to remove water vapor from the sample, and that this effect could be employed to quantitate HONO via CL. Nafion™ is a sulfonated tetrafluoroethylene-based fluoropolymer-copolymer widely used for proton exchange membranes in fuel cells. The reactive sulfonic acid group is a superacid (pKa=−6) that has been used as a catalyst in synthetic chemistry. Nafion™ is also widely used for atmospheric measurements as a dryer in CL systems where it increases detection sensitivity by eliminating water vapor that otherwise quenches NO₂* upon collision. It is generally understood that Nafion™ accomplishes this by shuttling water through ionic channels created by the sulfonic acid groups. Having a humified sampling flow counter to dry air flowed through a Nafion™ tube creates a gradient of water concentrations that facilitates mass transfer through the polymer.

In at least one aspect of the present disclosure, the use of Nafion™ as a catalytic converter to measure HONO via CL by characterizing the sensitivity of the detection scheme as a function of relative humidity, temperature, and catalyst surface area is considered. Additionally or alternatively, selectivity of the method for HONO in the presence of NOₓ, HNOₓ, and NH₃ is considered. The selectivity of the technique for HONO may be demonstrated by conducting an intercomparison between the Nafion™. CL method and negative ion proton transfer chemical ionization mass spectrometry (NI-PTR-CIMS) in a simulation chamber and indoor air. Results from such a demonstration may indicate the instrument attains sub-ppb detection limits of HONO in ambient air, in addition to being able to measure NOₓ. A chemical mechanism that explains the reaction of HONO on Nafion™ is also disclosed and the implications of this chemistry are discussed in the context of potential interferences introduced to CL analyzers that use Nafion™ to remove water vapor from gas sampling lines.

### SUMMARY

According to a first aspect of the present disclosure, a system adapted to convert gaseous nitrous acid into gaseous nitric oxide includes a catalytic converter and a nitric oxide analyzer including a gas inlet. The catalytic converter includes a polytetrafluoroethylene tube and one or more concentric tubes positioned within the polytetrafluoroethylene tube, wherein the one or more concentric tubes comprise of sulfonated tetrafluoroethylene-based fluoropolymer-copolymer.

The catalytic converter is coupled to the gas inlet of the nitric oxide analyzer so that a flow of gas is pumped through the catalytic converter into the nitric oxide analyzer. The catalytic converter converts gaseous nitrous acid included in the flow of gas into nitric oxide, and wherein the nitric oxide analyzer detects the nitric oxide in the flow of gas.

In some embodiments, the nitric oxide analyzer may have a limit of detection for detecting nitric oxide, and the catalytic converter may be adapted to measure nitrous acid concentrations of at least the limit of detection of the nitric oxide analyzer.

In some embodiments, the one or more concentric tubes may include at least five concentric tubes. In some embodiments, the at least five concentric tubes may define a surface area of sulfonated tetrafluoroethylene-based fluoropolymer-copolymer, the catalytic converter may defines a volume, and a surface area-to-volume ratio is at least 25, depending on the flow requirements of the nitric oxide analyzer. In some embodiments, the one or more concentric tubes includes six concentric tubes, and the surface area-to-volume ratio is at least 30, depending on the flow requirements of the nitric oxide analyzer. In some embodiments, the surface area-to-volume ratio results in a conversion efficiency of at least 33%.

In some embodiments, the system may further include a perfluoroalkoxy alkane tube and a valve system coupled to the perfluoroalkoxy alkane tube and the catalytic converter to selectively direct the flow of gas through the catalytic converter or the perfluoroalkoxy alkane tube. In some embodiments, nitric oxide may be measurable through the perfluoroalkoxy alkane tube.

In some embodiments, the system may further include a temperature-controlled oven that maintains a predetermined operating temperature and requires an inlet flow of humidified air. The catalytic converter may be located inside the temperature-controlled oven. In some embodiments, the predetermined operating temperature may be about 40° C.

According to another aspect of the present disclosure, a system adapted to convert gaseous nitrous acid into gaseous nitric oxide may include a catalytic converter and a nitric oxide analyzer including a gas inlet. The catalytic converter omcides a polytetrafluoroethylene or glass tube and one or more glass substrates positioned within the polytetrafluoroethylene or glass tube. The one or more glass substrates are coated in a sulfonated tetrafluoroethylene-based fluoropolymer-copolymer resin.

The catalytic converter is coupled to the gas inlet of the nitric oxide analyzer so that a flow of gas is pumped through the catalytic converter into the nitric oxide analyzer. The catalytic converter converts gaseous nitrous acid included in the flow of gas into nitric oxide, and the nitric oxide analyzer detects the nitric oxide in the flow of gas.

In some embodiments, the nitric oxide analyzer may have a limit of detection for detecting nitric oxide, and the catalytic converter may be adapted to measure nitrous acid concentrations of at least the limit of detection of the nitric oxide analyzer.

In some embodiments, the catalytic converter may further includes polytetrafluoroethylene mesh positioned within the polytetrafluoroethylene or glass tube to hold the one or more glass substrates inside the polytetrafluoroethylene or glass tube.

In some embodiments, the one or more glass substrates may comprise one or more of glass beads, glass capillaries, glass fiber, glass mesh, textured glass, glass or ceramic honeycomb substrate, or porous glass.

In some embodiments, the one or more glass substrates may define a surface area of sulfonated tetrafluoroethylene-based fluoropolymer-copolymer, the catalytic converter may define a volume, and a surface area-to-volume ratio is at least 25, depending on the flow requirements of the nitric oxide analyzer. In some embodiments, the surface area-to-volume ratio results in a conversion efficiency of at least 33%.

In some embodiments, the system may further include a perfluoroalkoxy alkane tube and a valve system coupled to the perfluoroalkoxy alkane tube and the catalytic converter to selectively direct the flow of gas through the catalytic converter or the perfluoroalkoxy alkane tube. In some embodiments, nitric oxide may be measurable through the perfluoroalkoxy alkane tube.

In some embodiments, the system may further include a temperature-controlled oven that maintains a predetermined operating temperature and requires an inlet flow of humidified air. The catalytic converter may be located inside the temperature-controlled oven. In some embodiments, the predetermined operating temperature may be about 40° C.

### BRIEF DESCRIPTION OF THE DRAWINGS

The following description accompanies the drawings, all given by way of non-limiting examples that may be useful to understand how the described method and kit may be embodied.

FIG. 1 shows a schematic of a Nafion™-NOₓ-chemiluminescence (Nafion™-NOₓ-CL) instrument used for the measurement of NO, NO₂, and HONO by NO chemiluminescence (CL) using a Nafion™ converter;

FIG. 2A is a graph comparing signal intensity achieved by a photolytic converter and the Nafion™ converter;

FIG. 2B is a graph comparing HONO-to-NO conversion efficiency of the photolytic converter and the Nafion™ converter;

FIG. 3 is a graph showing conversion efficiency of the Nafion™ converter as a function of absolute humidity and relative humidity (RH);

FIG. 4A is a graph showing conversion efficiency of the Nafion™ converter as a function of a surface area of exposed Nafion™ tubing of the Nafion™ converter;

FIG. 4B is a graph showing conversion efficiency of the Nafion™ converter as a function of residence time of gas in a Nafion™ reactor;

FIG. 5A is a graph showing conversion efficiency of the Nafion™ converter as a function of oven temperature;

FIG. 5B is a graph showing conversion efficiency change after heating the Nafion™ reactor to 90° C.;

FIG. 6A is a time series of simulated chamber measurements of HONO for the Nafion™-CL instrument and a chemical ionization mass spectrometer (CIMS);

FIG. 6B is a graph correlating the simulated chamber measurements of HONO for the Nafion™-CL instrument and the CIMS;

FIG. 6C is a residual plot of the linear correlation of FIGS. 6A and 6B;

FIG. 7A is a time series of room air measurements of HONO for the Nafion™-CL instrument and the CIMS;

FIG. 7B is a graph correlating the room air measurements of HONO for the Nafion™-CL instrument and the CIMS;

FIG. 7C is a residual plot of the linear correlation of FIGS. 7A and 7B;

FIG. 8 is a cross-sectional top view of the Nafion™ converter;

FIG. 9 is a cross-sectional front view of the Nafion™ converter having five prefabricated Nafion™ tubes contained within a larger PTFE tube;

FIG. 10 is a graph showing NO calibrations through blank tubing and the Nafion™ converter;

FIG. 11 is a graph showing the ratio of NO concentration measured at an indicated humidity to NO concentration measured under dry conditions at a CL detector as a function of carrier gas humidity;

FIG. 12 is a schematic of a commercially-available negative ion proton transfer CIMS using acetate as a reagent ion used to verify performance of the Nafion™ converter,

FIG. 13 is a graph showing raw data from a NOₓ-CL analyzer equipped with the Nafion™ converter and collected at the indicated relative humidity settings;

FIG. 14 is a graph comparing NO₂ concentrations measured by the NOₓ-CL analyzer when sample gas is flowed through the Nafion™ converter or when bypassing the Nafion™ converter,

FIG. 15 is a graph showing the ratio of O₃ concentration measured after it is flowed through the Nafion™ converter to the ratio of O₃ concentration measured before it reaches the Nafion™ converter as a function of initial ozone concentration;

FIG. 16 is a graph showing NO concentrations reaching the NOₓ-CL analyzer when exposed to different concentrations of ozone when the sample gas bypasses the Nafion™ converter and when the sample gas passes through the Nafion™ converter,

FIG. 17 is a graph showing O₃ interference as a percent increase in NO as a function of ozone concentration;

FIG. 18 is a graph comparing NO concentrations determined in air containing a high concentration of O₃ when measured through the Nafion™ converter or when bypassing the Nafion™ converter;

FIG. 19 is a time series of indoor air measurements using the single channel NOₓ-CL analyzer equipped with the Nafion™ converter, demonstrating its ability to measure NO, HONO, and NO₂ with a single instrument, and showing the limit of detection of the analyzer (horizontal dashed line);

FIG. 20 is a schematic of a mechanism responsible for HONO-to-NO conversion on Nafion™;

FIG. 21 is a top view of another embodiment of the Nafion™ converter,

FIG. 22 is a cross-sectional front view of the Nafion™ converter of FIG. 21;

FIG. 23 is a top view of an additional embodiment of the Nafion™ converter,

FIG. 24 is a cross-sectional front view of the Nafion™ converter of FIG. 23; and

FIG. 25 is a schematic of the Nafion™-chemiluminescence (Nafion™-CL) instrument.

### DETAILED DESCRIPTION

The present disclosure is directed to a catalytic converter 12 which converts gaseous nitrous acid (HONO) into gaseous nitric oxide (NO). In some aspects, the catalytic converter 12 converts HONO into NO with 100% efficiency.

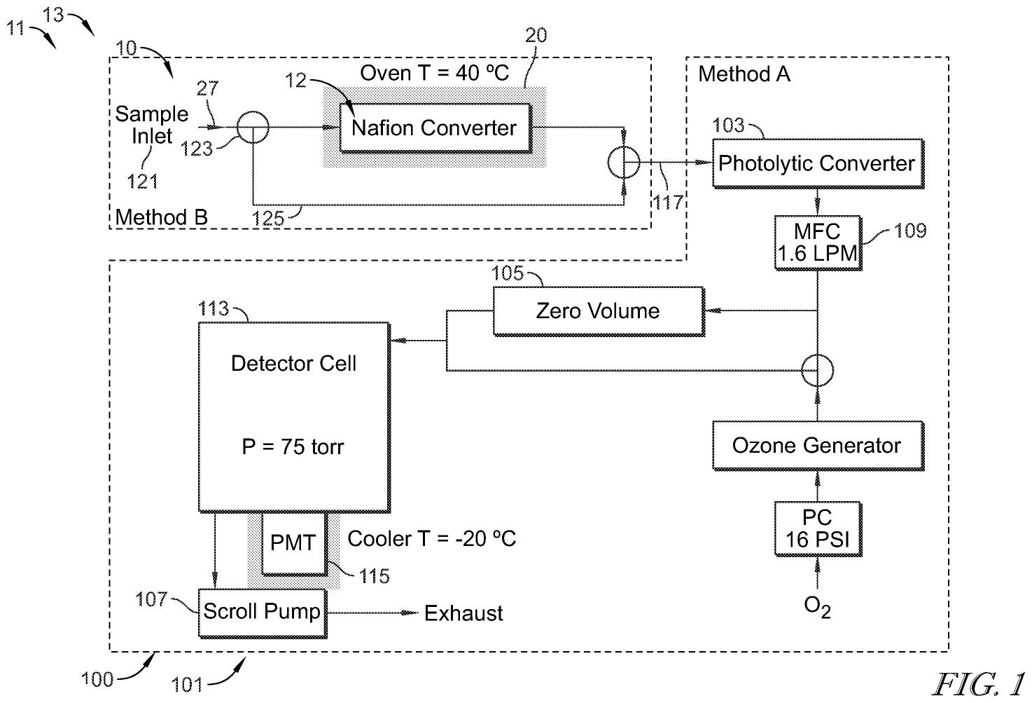

A highly selective catalytic converter 12 of the present disclosure quantitates nitrous acid (HONO) as shown in FIGS. 1, 8, 9, and 21-24. HONO is a photochemical precursor to nitric oxide (NO) and hydroxyl (OH) radical that drives formation of ozone and other air pollutants in the atmosphere. The catalytic converter 12 is made from a sulfonated tetrafluoroethylene-based fluoropolymer-copolymer (e.g. Nafion™). Nafion™ converts HONO to NO with unity yield.

The catalytic converter 12 may be used as an inlet 117, 121 to any instrument, detector, system, or analyzer 100 that is capable of detecting NO (i.e., a NOₓ-CL analyzer). Therefore, the converter 12 measures HONO concentrations as low as the limit of detection of the instrument 100. For example, if a given detector 100 measures NO with a limit of detection of 50 parts per trillion, then the same detector 100 equipped with the converter 12 may measure HONO concentrations of 50 parts per trillion. The converter 12 is highly selective for HONO when tested against other common gas phase reactive nitrogen species such as nitrogen dioxide, nitric acid, and ammonia. The converter 12 may be used for air pollution monitoring.

The catalytic converter 12 may be used with commercially available and custom-built NOₓ-CL analyzers 100 that are based on infrared absorption spectroscopy, mass spectrometry, chemiluminescence detection, laser induced fluorescence, and other methods or techniques known in the art. The converter 12 may extend the capability of NOₓ-CL analyzers 100 by enabling them to measure HONO in addition to NO. Therefore, the converter 12 may provide an inexpensive, robust, and sensitive method to detect HONO in the atmosphere and indoor air.

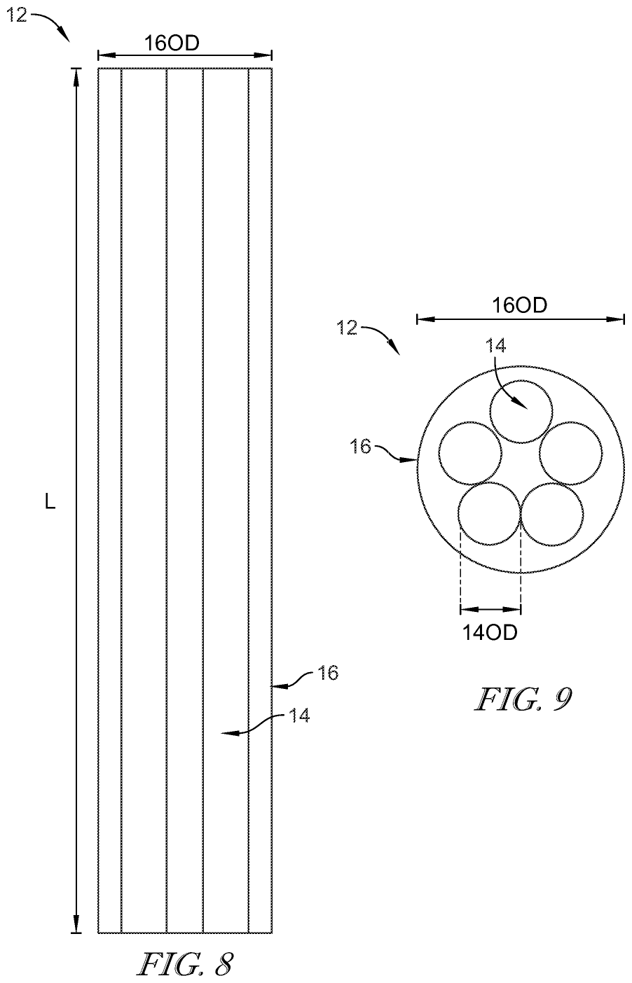

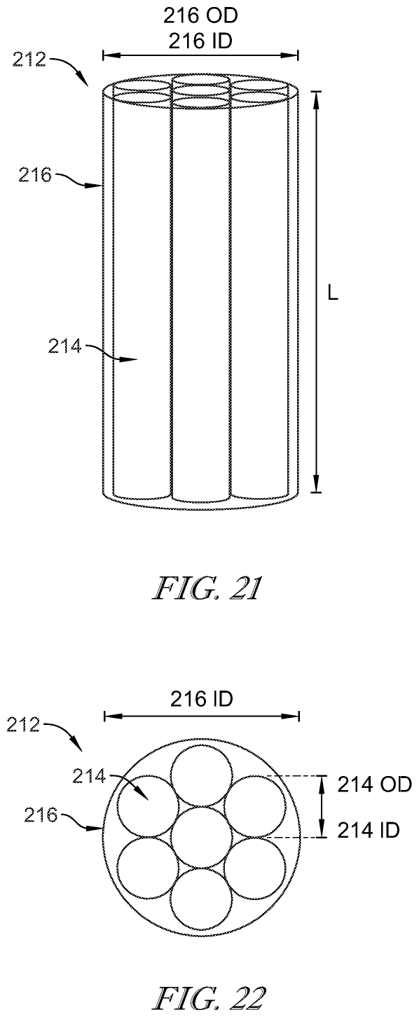

The converter 12 includes one or more concentric prefabricated Nafion™ tubes 14 contained within a polytetrafluoroethylene (PTFE) (e.g. Teflon™) tube 16, as shown in FIGS. 8-9. In some embodiments, the converter 12 may have five concentric tubes 14. In other embodiments, the converter 12 may have six concentric tubes 14. In some embodiments, the converter 212 may have seven concentric tubes 214, as shown in FIGS. 21-22. The dimensions of the one or more concentric tubes 14, 214 and the PTFE tube 16, 216 may vary depending on the surface area of the one or more concentric tubes 14, 214 and/or the gas flow rate. For example, the one or more concentric tubes 14, 214 may have an outer diameter 140D, 2140D of about 0.06 inches and/or an inner diameter 141D, 214ID of about 0.05 inches, and the PTFE tube 16, 216 may have an outer diameter 160D, 2160D of about 0.25 inches and/or an inner diameter 161D, 216ID of about 0.19 inches. In some embodiments, the PTFE tube 16, 216 and/or the one or more concentric tubes 14, 214 may have a length L of about 6.5 inches. In other embodiments, the dimensions of the one or more concentric tubes 14, 214 and/or the PTFE tube 16, 216 may vary as long as sufficient surface area is present to provide high conversion efficiency. Accordingly, the outer diameter 140D, 2140D may be greater or less than 0.06 inches, the inner diameter 14ID, 214ID may be greater or less than 0.05 inches, the outer diameter 160D, 2160D may be greater or less than 0.25 inches, and the inner diameter 16ID, 216ID may be greater or less than 0.19 inches.

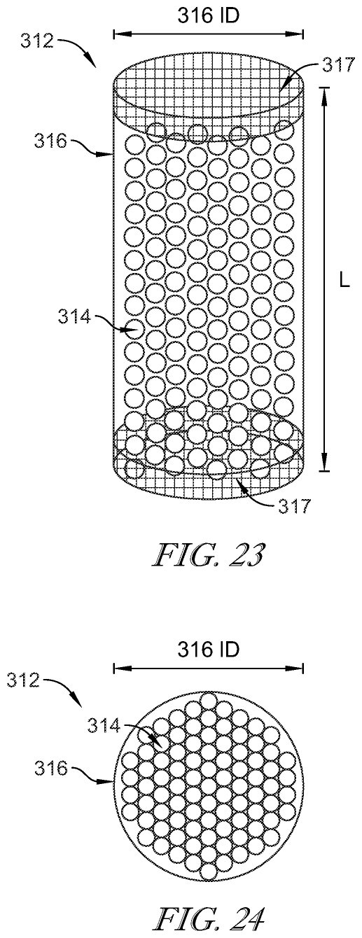

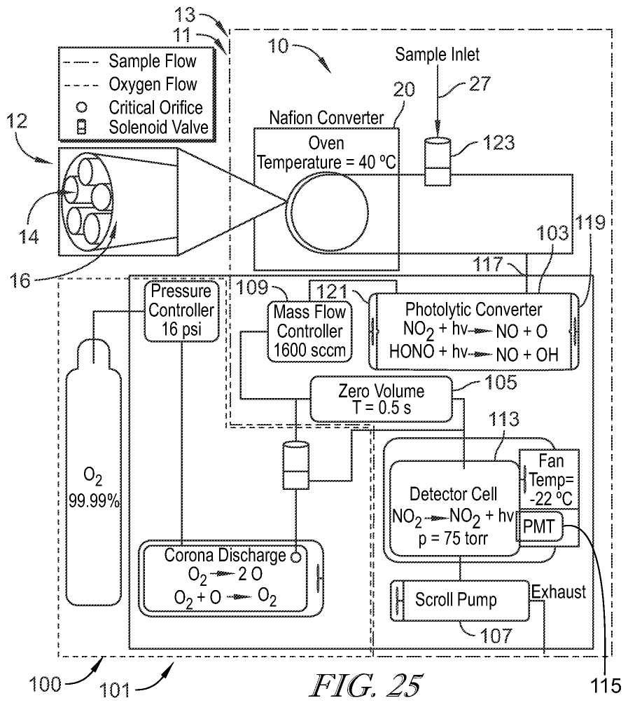

In another embodiment of the converter 312 as shown in FIGS. 23 and 24, a PTFE or glass tube 316 having an outer diameter 316OD of about 0.75 inches is packed with one or more glass substrates, 314, such as glass beads (3-4 mm in diameter) that are coated in a Nafion™ 117 resin, for example. In other embodiments, the PTFE or glass tube 316 may be packed with glass fiber, glass mesh, glass capillaries, textured glass, glass or ceramic honeycomb substrate, porous glass, or any glass surface that provides a high surface area. The coated glass beads 314 are held in the tube 316 between PTFE mesh 317. The tube 316 may have an inner diameter 316ID of 0.69 inches and a length L of 12 inches. The tube 316 dimensions and amount of coated glass beads 314 in the tubing 316 may vary to accommodate larger or smaller flow rates and device form factors. In other embodiments, the dimensions of the coated glass beads and/or the tube 316 may vary as long as sufficient surface area is present to provide high conversion efficiency. Accordingly, the diameter of the glass beads may be less than 3 mm or greater than 4 mm, the inner diameter 316ID may be greater or less than 0.69 inches, and the outer diameter 316OD may be greater or less than 0.75 inches.

Unless otherwise indicated herein, the converter 12 collectively refers to the converters 12, 212, and 312.

The converter 12 is included within a temperature-controlled unit or oven 20 that maintains a predetermined operating temperature and requires an inlet flow of humidified air. In some embodiments, the predetermined operating temperature is about 40° C. The converter 12 is attached to a gas inlet 117 of the NOₓ-CL analyzer 100. A flow of sample gas 127 is pumped through the converter 12 and into the NOₓ-CL analyzer 100. Any HONO present in the sample gas 127 is converted into NO by the converter 12 and is detected as NO by the NOₓ-CL analyzer 100.

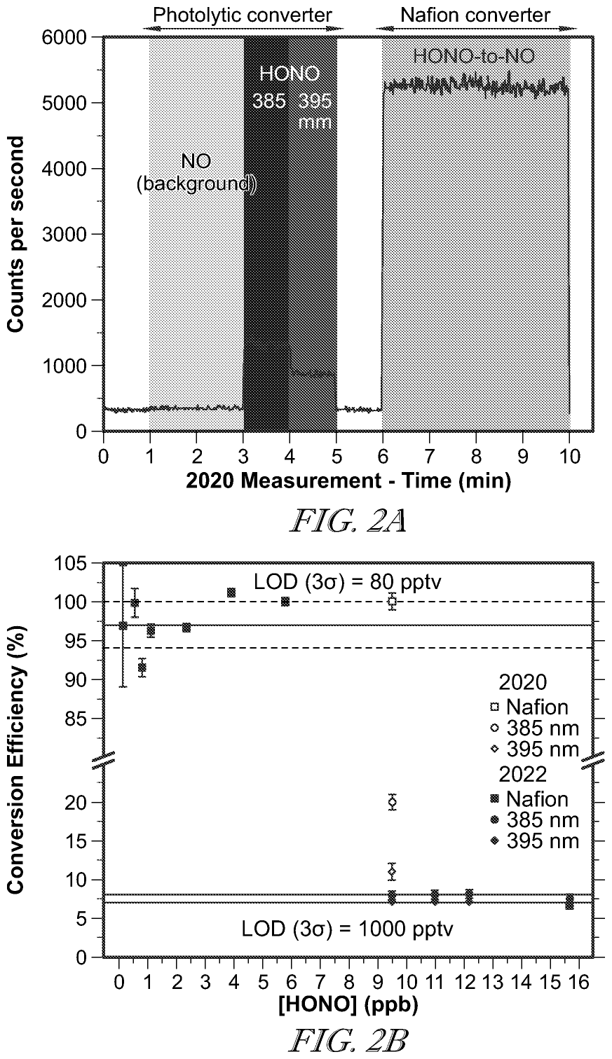

FIGS. 1 and 25 show the Nafion™ converter or reactor 12 and method 10 of use thereof. The Nafion™ reactor 12 is coupled to an inlet 117 of a commercially-available NO, chemiluminescence (NOₓ-CL) detector, system, or analyzer 100 and method 101. A Nafion™-NOₓ-CL instrument, system 11, or method 13 comprises the Nafion™ reactor 12 and the NOₓ-CI, analyzer 100. Use of the Nafion™ reactor 12 may lead to a significant enhancement in sensitivity of the analyzer 100 with respect to HONO detection. As shown in FIG. 2A, early measurements using the NOₓ-CL analyzer 100 showed a 5-fold enhancement in signal when a high purity flow of HONO (8.3 ppb) is directed through the Nafion™ converter 12 relative to the signal achieved by a photolytic converter. As shown in FIG. 2B, this enhancement may grow as LED conversion efficiency (CE) decreases over time. HONO-to-NO CE may be characterized as a function air flow, relative humidity, concentration, and residence time inside the converter 12, as well as converter surface area and temperature, in order to determine preferred converter geometry and/or conditions. For most measurements described herein, parameters that were not varied during an experiment were set to preferred conditions with respect to maximizing HONO-to-NO conversion.

The mechanism responsible for HONO-to-NO conversion on Nafion™ may be constrained by observations such as: (1) The effective stoichiometry of the reaction is 1:1 with respect to HONO and NO; (2) the reaction requires H₂O; and (3) Nafion™ acts as a catalyst since its activity shows no signs of waning over time. It may be assumed that absorption of HONO into acidic Nafion™ channels leads to nitrosonium ion, NO*, at pH<2, such as according to reaction (R1):

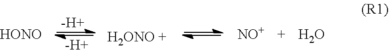

It is known that sulfonic acid head groups (pKₐ=−6) have a strong-acid character and that Nafion™ has the ability to conduct protons. In addition, a similar reaction occurs when nitrite reacts with triflic acid, which is a monomeric analog to Nafion™.

The mechanism shown in FIG. 20 is therefore considered. Step (a) involves nitrosylation of the sulfonic acid oxygen by NO*. Attachment of a second nitrosonium ion in step (b) yields a sulfonic acid ester of trioxodinitrate. This intermediate is structurally similar to Angeli's salt (Na₂N₂O₃). Trioxodinitrate is known in the art to decompose under acidic conditions (pH<3) to NO and H₂O. In the present disclosure, the protonation of the trioxodinitrate at the sulfonate oxygen in step (c) releases N₂O₂, which promptly decomposes to two NO molecules in step (d); in the process, the Nafion™ sulfonate group is regenerated, completing the catalytic cycle. The mechanism shows that two molecules of HONO react with a sulfonate site to form two molecules of NO (reaction (R2)), which is consistent with the unity CE of HONO to NO.

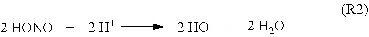

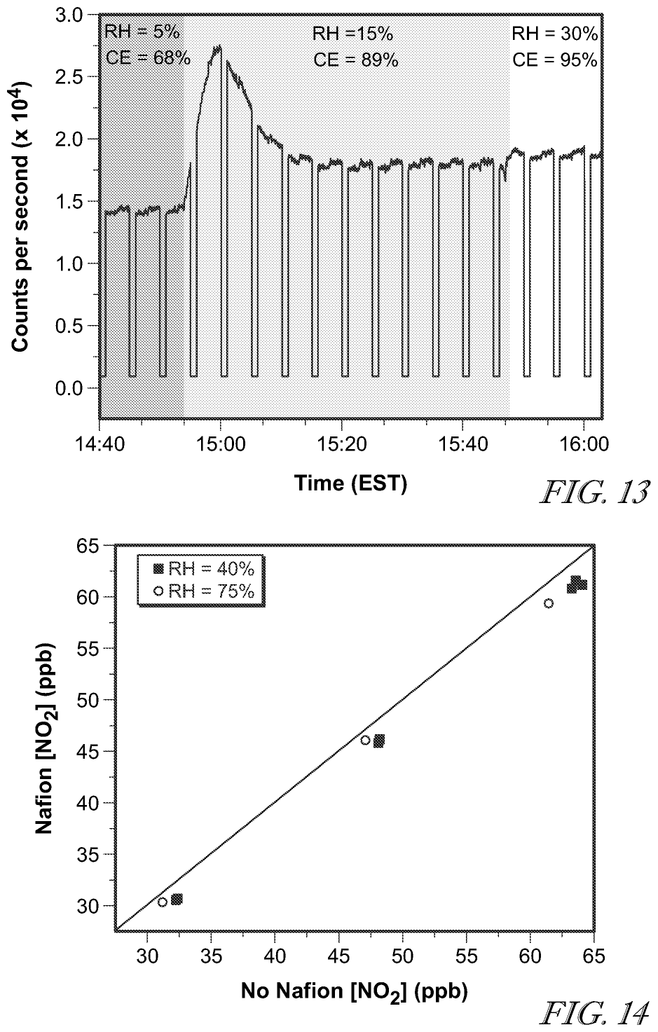

Although not explicitly included in the mechanism of FIG. 20, water does play a crucial role in facilitating the reaction steps by facilitating proton transfer and stabilizing ionic intermediates. In addition, water facilitates conduction of ions through the Nafion™ channels, which are required for the formation of the intermediates indicated in the mechanism of FIG. 20. Evidence for this comes from HONO uptake experiments carried out under dry conditions. As shown in FIG. 13, HONO uptake onto Nafion™ is efficient, presumably leading to accumulation of adsorbed NO₂ and NO*, which is then released in a pulse of NO when the relative humidity of the carrier gas is increased to above 30%.

The present disclosure includes Nafion™-NOₓ-CL instrument or system 11 having a commercially-available single channel NOₓ-CL system or analyzer 100 that is adapted with a Nafion™ converter 12 to enable sequential measurements of NO, NO₂, and HONO. The Nafion™ reactor or converter 12 is able to selectively convert 100% of HONO to NO for thousands of hours of use without losing efficiency, and at a much lower cost relative to other conversion methods, making it a preferred technique for HONO measurements by NO detection. The Nafion™-NOₓ-CL instrument 11 achieves tens of ppt limit of detection (3σ) for HONO, NO, and NO₂. However, there are CL instruments with LODs for NO as low as 5 ppt. By equipping these analyzers 100 with a Nafion™ converter 12 channel, similar LODs can be achieved for HONO. Utilizing a two or three detector system 11 may allow for high frequency (2 Hz) measurement of NO, NO₂, and HONO. Another benefit of using the Nafion™ converter 12 is to limit wall losses of HONO in long sampling tubes. Placing the Nafion™ reactor 12 at the end of a long sampling line may convert HONO to the comparatively less reactive NO, which is not prone to adsorb to tubing even under humid conditions.

It is considered in the present disclosure that HONO reacts on Nafion™ surfaces catalytically to produce NO. This reaction depends on the relative humidity of input gas, temperature, surface area, and sample's contact time with the Nafion™ surface. With respect to NOₓ-CL analyzers 100 that employ in-line Nafion™ driers, implications may include: (1) Depending on the drier dimensions and relative humidity, they may overestimate NO concentrations due to a HONO interference, and (2) NOₓ-CL instruments 100 used measure HONO concentrations using the photolytic dissociation or a carbonate denuder may underestimating HONO concentration.

### EXAMPLES AND METHODOLOGY

The following examples provide further non-limiting disclosure of the catalytic converter 12.

### Example 1: Chemiluminescence Measurements

Concentrations of NO, NO₂, and HONO were measured by a custom-built single channel NOₓ chemiluminescence (CL) detector or analyzer 100 (Air Quality Design, Inc.; Golden, CO), as shown in FIGS. 1 and 25. The instrument operates in one of two methods: Method A, which uses photodissociation, and Method B, which uses a Nafion™ converter 12 or reactor. Both methods required operating on a five-minute measurement cycle that allowed for the determination of NO, nitrogen dioxide (NO₂), and HONO mixing ratios.

Measurements proceeded as follows: (1) Sampled air was first drawn through a zero volume 105 where it was reacted with ozone (O₃) generated internally by a corona discharge or ozone generator allowing for a background measurement due to the short NO₂ chemiluminescence lifetime (10's of μs); (2) O₃ was diverted to a reaction or detector cell 113 connected to a photon detector 115, which allows detection of NO₂* luminescence that is directly proportional in intensity to the NO mixing ratio; (3) and for Method A, sampled air is first flowed through a photolysis cell or photolytic converter 103 equipped with two LEDs 119, 121 with peak wavelengths 385 nm and 395 nm, respectively; the LEDs 119, 121 are cycled sequentially to determine the concentration of NO₂ and HONO by differential photolysis.

Method B involved modifying the sample inlet 121 by using an automated valve system 123 that allowed the sample gas flow 27 to toggle between the Nafion™ reactor 12 or an empty perfluoroalkoxy alkane (PFA) tube 125. This altered the five-minute measurement cycle as follows: 1 minute of background measurements through the blank tubing 125, 1 minute of NO measurements though the blank tubing 125, 1 minute of background measurements through the Nafion™ reactor 12, 1 minute of HONO measurements through the Nafion™ reactor 12, and 1 minute of NO₂ measurements through the Nafion™ reactor 12 with the 395 nm LED 121. FIGS. 1 and 25 show the instrument schematic for the configuration used in Method B.

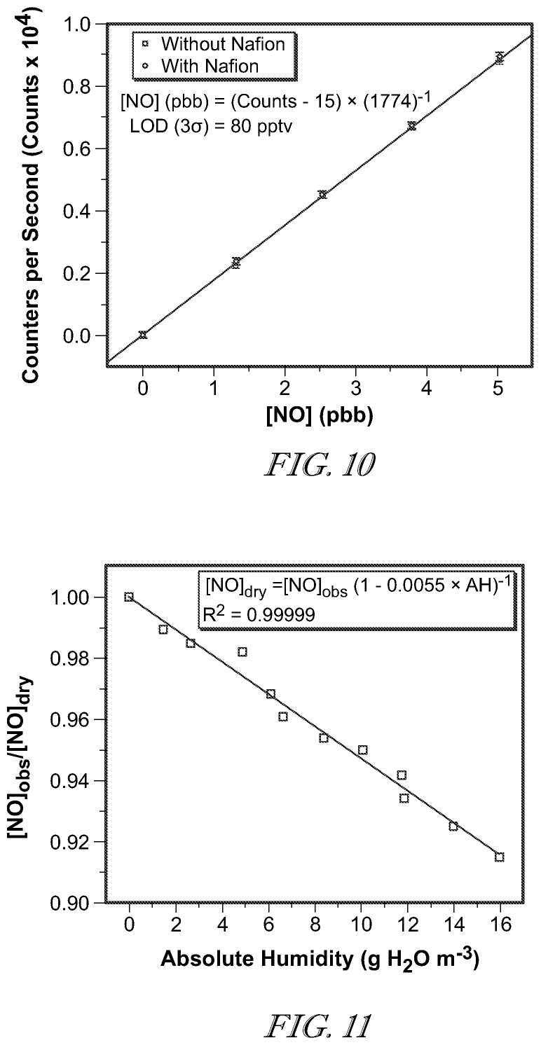

Multipoint calibrations (at least 5 points) of the NOₓ-chemiluminescence detector or analyzer 100 were made daily. To calibrate the detector or analyzer 100, a small controlled (MKS GE50 20 cm³/min, Mass Flow Controller 109, ±1% uncertainty) flow of NO in nitrogen (N₂) (465=10 ppb, Praxair, verified by long-path FR-IR) was diluted with a controlled flow of high punty air (FT-IR Purge Gas Generator; Parker; Cleveland, OH). Multipoint calibrations between 1 and 5 ppb NO (R²=0.9999) were performed to ensure linearity of the response over the relevant concentration range. The long-term sensitivity of the detector or analyzer 100 varied between 1.67 to 1.91 counts per second (cps) per ppb NO over the course of the experiment period. FIG. 10 shows a typical calibration.

Water effectively quenches NO₂* chemiluminescence upon collision, decreasing the signal intensity relative to a dry sample. This may be resolved by introducing a Nafion™ dryer at the inlet 117 to significantly reduce water inlet water, however as Nafion™ was found to react with HONO, the dryer had to be removed. Thus, a correction factor was applied based on the measured absolute humidity at the inlet 117. The observed NO concentration ([NO]_{obs}) was found to decrease linearly relative to the NO concentration determined in dry air ([NO]_{dry}) with increasing absolute humidity as shown in FIG. 11.

Photolysis efficiencies of the 385 and 395 nm LEDs 119, 121 with respect to NO₂ are determined periodically. To do this, zero air is flowed through a stable ozone generator (UVP Upland, California) to generate an excess of O₃ (˜200 ppb), which is then mixed with NO in N₂ to generate NO₂ (92.5±0.3% NO-to-NO₂ conversion at the detector). A correction factor for the residence time between the photolytic converter 103 and the detector cell 113 was applied to account for the true NO₂ concentration in the photolytic converter 103, as well as the back reaction of the photolysis products with ozone. A multipoint calibration found stable NO₂ conversion efficiencies over a range of 1-5 ppb, leading to calculated conversion efficiencies for the 385 nm LED 119 (51.6±1.3%) and 395 nm LED (90.4±1.5%) 121.

The limit of detection (LOD) of NO is found by taking three times the standard deviation (3σ) of a zero-air measurement divided by the slope of the regression line found during daily calibrations. This produces LODs of between 64 and 150 ppt (mean=80±18 ppt) throughout the period of characterization. The LOD of NO₂ is proportional to the limit of detection of NO divided by the LOD_{NO} by the conversion efficiency (CE) of the 395 nm LED 121. This produced a range of detection limits between 71 and 167 (mean: 88±20 ppt).

### Example 2 Nafion™ Converter

Nafion™ converters 12 were built from commercially available Nafion™ tubing (e.g. Nafion™ 117, inner diameter (ID)=0.138 cm, wall thickness=0.025 cm, Perma Pure LLC; Lakewood, NJ). As shown in FIG. 25, Nafion™ tubing 14 was pulled through % in outer diameter (OD) PFA tubing 16 (ID= 3/16 in, wall thickness= 1/16 in), either in groups of five or six, to generate reactors 12 with different surface area to volume ratios (A/V=25.5 and 30.6, respectively). Reactors 12 were cut into different lengths to test the effect of surface area on reactivity. Additionally, a third type of reactor 12 was built based on the standard dryer design for chemiluminescence instruments. This design consisted of a single Nafion™ tube 14 running concentrically within a ¼ in PFA tube 16 with a 1 liter per minute (LPM) zero air counter flow. A fourth type of reactor 312 uses a 12 inch long, 0.75 inch outer diameter PTFE or glass tube 316 packed with glass beads 314, which are coated with a sulfonated tetrafluoroethylene-based fluoropolymer-copolymer resin (for example, Nafion™ 117). The PTFE or glass tube 316 is capped on both ends by a PTFE mesh 317 (2 mm hole size) to keep the coated beads in place. Reactors 12, 212, 312 were pretreated by flushing with dry zero air for 24 hours, followed by zero air at ˜100% relative humidity (RH) for 72 hours. The reactor 12, 212, 312 was used in a gas chromatograph oven 20 set at 40° C.

### Example 3: HONO Calibration

Calibration of the NOR-CL analyzer 100 for HONO is based on the NO calibration described in the examples above and knowing the HONO-to-NO CE of the Nafion™ reactor 12. The HONO-to-NO CE of Nafion™ was determined by measuring the concentration of HONO_{(g)} present in a gas stream before and after it flowed through the converter 12. A pure source of HONO that could be used in serial dilutions was produced in situ using a coated wall flow reactor. The method includes reacting hydrochloric acid with sodium nitrate salt according to reaction (R3):

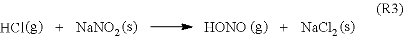

To prepare the reactor 12, a solution of sodium nitrite (20 g L; Sigma Aldrich; St. Louis, MO) was prepared using equal parts methanol (Reagent Grade; Avantor; Radnor, PA) and deionized water (v/v) (resistivity=18.2 Ma cm at 25° C.; Milli-Q; MilliporeSigma; Burlington, MA), and a small amount glycerol (1.0 g L⁻¹; GR ACS; Supelco, Inc.; Bellefonte, PA) to act as a binding agent. A section of PFA tubing 16 (OD=¾ in, length=16.5 cm) was filled with the solution and the ends were plugged by two rubber stoppers containing small diameter holes to allow evaporated solvent to escape. The filled tubes were and heated at 40° C. while rotating for 24 hours, resulting in a thin coating of NaNO₂ on the inner surface of the tube.

To produce a flow of HONO, high purity air humidified to 50% RH was flowed (200 cm³/min) through a hydrochloric acid (HC) permeation device (20.2% HCl; VICI Metronics; Poulsbo, WA) connected in series to the sodium nitrite (NaNO₂) reactor, both of which were housed in a gas chromatography (GC) oven for temperature control. Humidified carrier gas air was produced by combining equal flows of dry air with air humidified by first purging it through a glass bubbler containing deionized water. Optimum stability of the HONO source was found when the oven was set to 50° C. and was achieved 30-45 minutes after heating began. The flow exiting the oven was mixed in a 1:10 ratio with a dilution flow of high purity air before entering instrumentation.

HONO concentrations were confirmed using a custom-built incoherent broadband cavity enhanced absorption spectrometer (IBBCEAS). Briefly, a temperature-controlled incoherent, broadband light-emitting diode (NCSU0333B(T); Nichia Corp.; Anan, Japan) with a center wavelength of 366.49 nm was focused into a Teflon™ cavity (L=1.013 m, ID=254 cm) using an aspherical lens. Two highly reflective mirrors (reflectivity=0.9996-0.9997) were placed at each end of the cavity, with a resulting path length of 3185 m. Values for an optical extinction value due to absorption by HONO, ∞_{HONO}, were determined as known in the art. Data analysis was performed in a custom-made web application software that was developed in R (R version 4.0.2, R Development Core Team) for utilization with IBBCEAS instrumentation. The software is used to determine IBBCEAS path lengths, generate reference spectra based on literature values for absorption cross-sections, process spectra for analysis, and generate a report of analyte mixing ratios using DOAS fitting algorithm of non-linear fits of reference spectra. This software was used to determine HONO mixing ratios within the cavity of the IBBCEAS instrument, which was used in tandem with the Nafion™ converter 12 to determine conversion efficiency. The spectral overlap of α_{HONO} from the measured spectra was fitted to a reference spectrum built from a specific mixing ratio, temperature, and pressure of literature HONO and NO₂ absorption cross sections and a second order polynomial using the Gauss-Newton non-linear curve fitting according to equation 1:

$${α}_{H O N O} = {{a}_{0} ( λ )}^{2} + {a}_{1} ( λ ) + {a}_{2} + {c}_{1} {α}_{H O N O}^{r e f} ( λ ) + {c}_{2} {α}_{N {O}_{2}}^{r e f} ( λ ) \qquad ( 1 )$$

Here, a₀, a₁, and a₂ refer to the polynomial terms associated with instrumental properties and drift. The mixing ratio of HONO was determined by multiplying ci by the concentration of the reference spectra. HONO concentrations were collected using 1 min integration times and averaging for 10 min. The LOD for the IBBCEAS system was around 4 ppb for HONO for this integration time. During calibrations, HONO measurements were performed simultaneously using the IBBCEAS method and Nafion™-NOₓ-CL method 13.

### Example 4: Chemical Ionization Mass Spectrometer

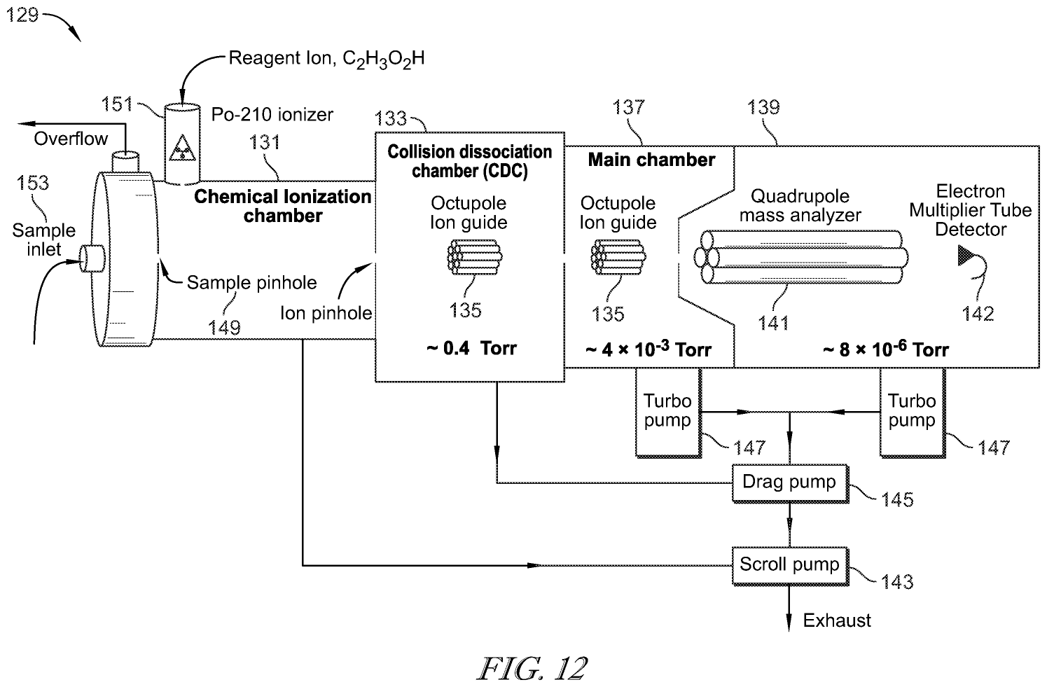

A commercially-available negative ion proton transfer chemical ionization mass spectrometer (NI-PTR-CIMS) 129 was used in tandem with the Nafion™-NOₓ-CL system 11 to intercompare instrument performance with respect to quantitating HONO concentrations in a chamber and room air. The NI-PTR-CIMS 129 (THS instruments, Atlanta, GA), as suggested in FIG. 12, is comprised of four differentially pumped regions: an ion-molecule reaction chamber (IMR) 131 operated at 18 Torr, a collisional dissociation chamber (CDC) 133 with an octupole ion guide 135 (0.4 Torr), a second octupole ion guide chamber 137 (4×10⁻³ Torr), and a mass selection chamber 139 (8×10⁻⁵ Torr) with an TD of ⅜ in (9.5 mm) quadrapole mass selector 141 and a channeltron electron multiplier detector 142 (DeTech 470). The IMR 131, CDC 133, ion guide 135, 137 and mass analyzer 139 regions are respectively evacuated by a scroll pump 143 (Edwards nxds15i), a molecular drag pump 145 (Adixen MDP 5011), and two turbo pumps 147 (Varian TV-81M).

Room air was sampled at 3.4 L/min through a ¼ in (0.635 cm) Teflon™ tube into the IMR 131 region by differential pressure through a 0.0135 in pinhole 149. Sample ionization was achieved by negative ion proton transfer with acetate reagent ion. The reagent ion flow was prepared by mixing 2 L/min of N₂ with 4 cm³/min of N₂ saturated with acetic acid from a heated (40° C.) glass permeation device filled with 10 mL glacial acetic acid. This mixture flowed through a Polonium radioactive ion source 151 (NRD 2031) into the IMR 131, where the acetate ion abstracts protons from inorganic and organic acids in the sample gas. The operational declustering voltage differential between the IMR 131 and CDC 133 was 26 V. Nitrous acid was quantitated by calibrating the [NO₂]⁻ anion counts at m/z 46 as a function of HONO concentration via serial dilution. The LOD (3σ) was 45 ppt for 1 min averaging with 0.5 Hz integration time.

### Example 5: Concentration Dependence

The efficiency of HONO-to-NO conversion was determined for the NOₓ-CL system 100 over a range of HONO concentrations. As shown in FIG. 2B, the range of concentrations tested span low mixing ratios (<100 ppt) associated with environments experiencing negligible anthropogenic influence (i.e., forests) up to higher mixing ratio (˜8 ppb) that are found in polluted urban environments. Mean CE was 97±3% over the entire concentration range. This is compared to the HONO-to-NO CE for the 385 and 395 nm LEDs 119, 121, which are 7.93±0.02% and 7.03±0.02%, respectively. The limits of detection (LOD) for HONO was determined by taking the LOD of NO at the time of measurement and dividing it by the CE. This led to LOD for HONO of 80 ppt for the Nafion™ converter 12 and 1000 ppt for the photolytic converter 1-3.

Additional points were tested at higher concentrations of HONO (>20 pph) and the CE was found to be 100±0.3%. Thus, the CE is stable in the range of concentrations of 0-50 ppb for the Nafion™ reactor 12. HONO loss was determined by connecting the Nafion™ reactor 12 to a negative ion proton transfer chemical ion mass spectrometer (NI-PTR-CIMS) 129 and testing the decrease in HONO signal. It was found that 100% of HONO was lost when going through Nafion™ under preferred conditions over the entire concentration range. The variation in measured CE's associated with the lower concentrations were quite high due to errors associated with low flow gas rotameters used to control dilution flows.

### Example 6: Relative Humidity Dependence

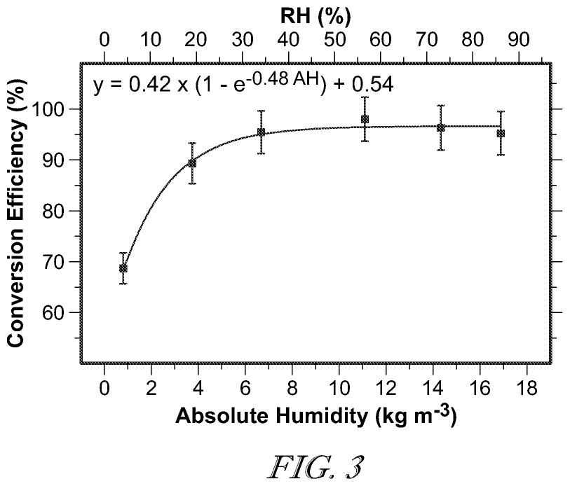

Nafion™ is used in the art as a dryer due to its ability to shuttle water through its semi-porous membrane without loss of other measured species. It has also been found in the art through topographic imaging that under conditions of low relative humidity, Nafion™ experiences a low density of isolated hydrophilic domains, where at a higher relative humidity, a network of tube-like domains begins to emerge. As such, water has been hypothesized to play an important role in the chemistry of HONO-to-NO conversion. To test this, a measurement was taken of the CE resulting when the reactor 12 is exposed to a flow of purified air (1600 cm³/min) containing 10.8 ppb HONO at a relative humidity of between 4 and 86%. As shown in FIG. 3, the HONO-to-NO CE strongly depends on the relative humidity of the sampled gas. CE was found to scale with relative humidity until it reaches 98%±0.4% at 50% RH. CE approached unity between 30-90%. This means to achieve maximum conversion the sample needs to be humidified upstream of the Nafion™ reactor 12.

An important observation pertains to an artifact that arises when Nafion™ is exposed to high concentrations of HONO at low relative humidity, as shown in FIG. 13. When exposed for an extended period, the CE is high initially (>90%), but drops to 70% after 15 mm. HONO loss determined by NI-PTR-CIMS 129 is still 100% during this time, suggesting that a portion of HONO is retained on the surface. Upon wetting the surface with 15% RH humidified air, a pulse is observed that is 30-40% greater than the input concentration; whereupon it levels off to the expected CE after 25 min. This effect is not seen when the sample is humidified to above 30% RH. This observation demonstrates that water plays a critical role in the mechanism of HONO-to-NO conversion and in maintaining stability of the system 10.

### Example 7: Surface Area and Residence Time

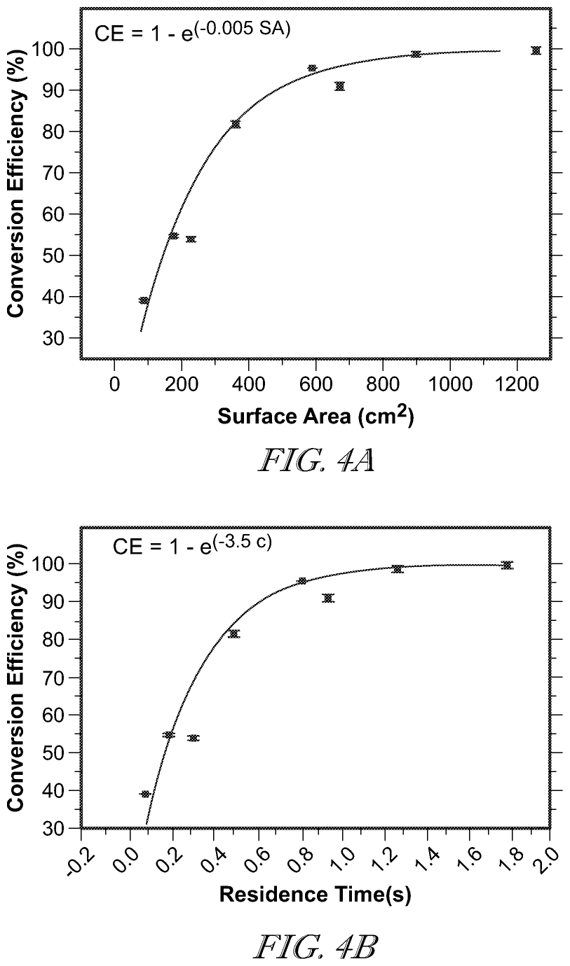

The dependence on HONO-to-NO CE on total Nafion™ surface area was explored using a relative humidity of 50% and an oven temperature of 40° C. Input air flow was set to 1600 cm³/min with a HONO concentration of 11 ppb. Different Nafion™ reactors 12 were used interchangeably, alone, or in sequence to test several different surface areas. The range of tested surface areas was 87 to 1257 cm². FIG. 4A shows a non-linear dependence of CE on Nafion™ surface area; whereby CE starts at 39±1% for the smallest reactor 12 and reaches 100±1% for the longest reactor 12. Surface area dependence of HONO-to-NO CE appeared to follow a non-linear fit (2=0.96). The minimum surface area needed for 100% conversion at 95% confidence is 900 cm², which was shorter than the longest tested reactor 12.

The first-order dependence on surface area means the reactor 12 can be scaled to residence time within a specific surface area to volume ratio. The surface area to volume ratio for the reactors 12 were 25 (for the five-tube reactor) and 31 (for the six-tube reactor). The FIG. 4B shows the CE as a function of residence time when using the five-tube reactors at a flow of 1600 cm³/min. Using a lower flow rate to increase residence time may increase CE with a lower total surface area. The opposite was confirmed when sending a higher flow rate through the Nafion™ (as the CE decreased), but the NOₓ-CL instrument 100 has a minimum operating flow rate of 1600 cm³/min; meaning improvements in CE could only be achieved by lengthening the reactor 12. For systems using lower sample flow rates, smaller reactors may be possible.

### Example 8: Temperature Dependence

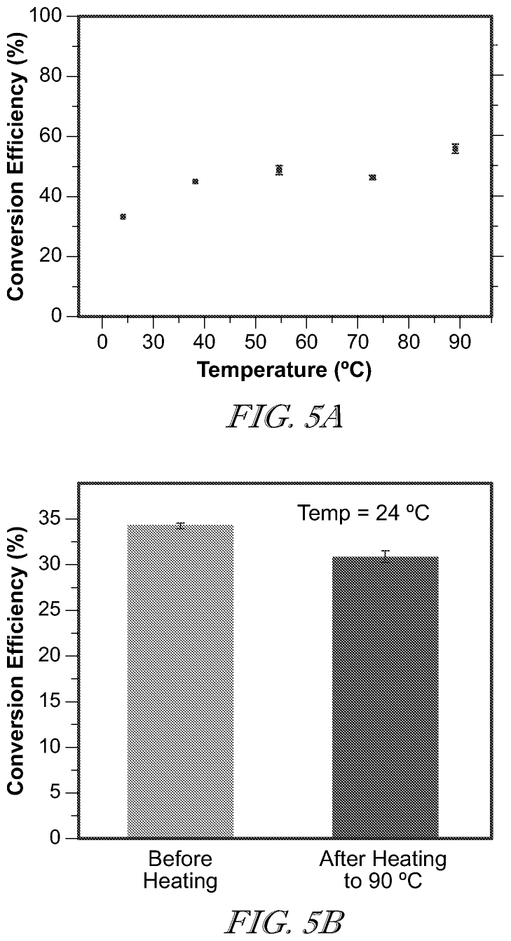

The effect of temperature on HONO CE over the range of 25-90° C. was tested. As shown in FIGS. 5A-B, increasing the temperature of the oven 20 used to house the reactor 12 increases CE. It was found that increasing temperature of the oven 20 from 20 to 90° C. increased the CE from 33±0.1% to 55±1.5%. Following heating at 90° C., the reactor 12 again tested at lower temperature; a 3.2% decrease in the CE was measured. Additionally, there was an observed browning of the Nafion™ surface. Though Nafion™ experiences thermal stability up to 280° C., it's possible that heating the surface caused dehydration of the sulfonic acid reactive sites, which has been found to limit the access to Nafion™ reactive sites. Though increasing temperature can increase CE temporarily, it appears that high temperature may permanently damage the Nafion™. Due to this, a preferred temperature of 40° C. was chosen when using testing other reactors.

### Example 9: Interferences

Since the Nafion™-CL method 11 does not directly detect HONO, the method 10 may be susceptible to interferences when measuring in a real environmental matrix. Systematic positive or negative measurement biases may result from reactions involving species other than the analyte that remove or produce NO; such interferences have been documented for CL analyzers that use photolytic and molybdenum converters. To test for interferences, several gas species were flowed through the Nafion™ converter 12 at different concentrations. It was investigated whether NO was lost to the Nafion™ reactor 12 by calibrating the NOₓ-CL system 100 using a tank of NO standard gas (for example, 465±10 ppb, Praxair, verified by FT-IR) in the presence and absence of the Nafion™ reactor 12. No statistical difference was found between the regression curves, as seen in FIG. 10 (p<0.001), for calibrations carried out under these two conditions. Similarly, loss of NO: in the Nafion™ reactor 12 was explored by measuring dilutions of a standard mixture of NO₂ (for example, 2.64±0.05 ppm, Praxair, verified by IBBCEAS) in purge zero air in the presence and absence of a Nafion™ reactor 12. The NO₂ source tank was found to have a 6-9% HONO impurity, as verified by NI-PTR-CIMS 129. Concentrations were tested at both 35% and 70% RH to check for NO₂-to-HONO conversion on tubing surfaces. Impurity HONO concentrations measured by the Nafion™-NOₓ-CL system 11 were around 6% and were not significantly different from the concentrations measured by NI-PT-CIMS 129 (p<0.01), meaning there was no measurable NO₂ interference using this method. It was found that for NO₂ concentrations greater than 20 pph, there was a 4% loss of NO₂ on the surface of Nafion™, as shown in FIG. 14. While uptake of NO₂ onto the Nafion did not produce a detectable interference, it demonstrates the need to bypass the Nafion™ converter 12 when quantifying NO: concentrations.

Nitric acid (HNO₃) and ammonia (NH₃) were also tested for potential interferences. Flows of each species (1700 cm³/min) were produced using different permeation devices and tested on the 1250 cm² converter 12. The HNO₃ permeation device, which was used to create a flow containing 25 ppb HNO₃ was found to have a 5% HONO contamination which was detected by both the NI-PTR-CIMS 129 and the Nafion™-NOₓ-CL systems 11; no additional interference from HNO₃ was detected. It was also found that there was no interference when a flow of 25 ppb of NH₃ was flowed through the system 11. Other possible interferences included organic peroxyacetyl nitrates and organonitrates. Both species may hydrolyze to NO₃⁻/HNO₃ under the highly acidic conditions present in Nafion™ pores. Thus, these species may behave similarly to HNO₃, which did not exhibit detectable interferences. Dinitrogen pentoxide (N₂O₅) is an important reactive nitrogen oxide that forms from the reaction of NO₂ and O₅ at night; however it may autoionize to NO₃⁻ and NO₂⁺ on surfaces. Both species may be present when Nafion™ is exposed to HNO₃; hence, N₂O₅ may not be an interference.

NO chemiluminescence instruments may exhibit a nonlinear response to observed NO mixing ratios due to the reaction of NO and O₃ in the sample flow path. This stems from the reaction of NO with atmospheric O₃, which decreases observed NO mixing ratios proportional to the concentration of O₃. This effect is accounted for by measuring O₃ with separate instrumentation and applying a correction based on the solution to the bimolecular integrated rate law (equation (2)).

$${[ NO ]}_{0} = \frac{[ {O}_{3} ] - [ NO ]}{\frac{[ {O}_{3} ]}{[ NO ]} {e}^{kt ( [ N O ] - [ {O}_{3} ] )} - 1} \qquad ( 2 )$$

In equation (2) [NO]₀ is the inlet concentration, [NO] is the concentration measured by the detector, [O₃] is the measured ozone concentration, k is the temperature-dependent rate constant for the reaction of NO and O₃, and t is the residence time of the sample between the inlet 117 and detector cell 113. Because the Nafion™-NOₓ-CL system 11 has two inlet configurations (path A: the Nafion™ reactor 12; path B: a blank Teflon™ tube 125) ozone concentrations may be different if O₃ is lost in path A to a greater extent than it is in path B. In this case, higher background NO concentrations may be measured in the sampling line containing the Nafion™ reactor 12, which may lead to overestimated HONO concentrations.

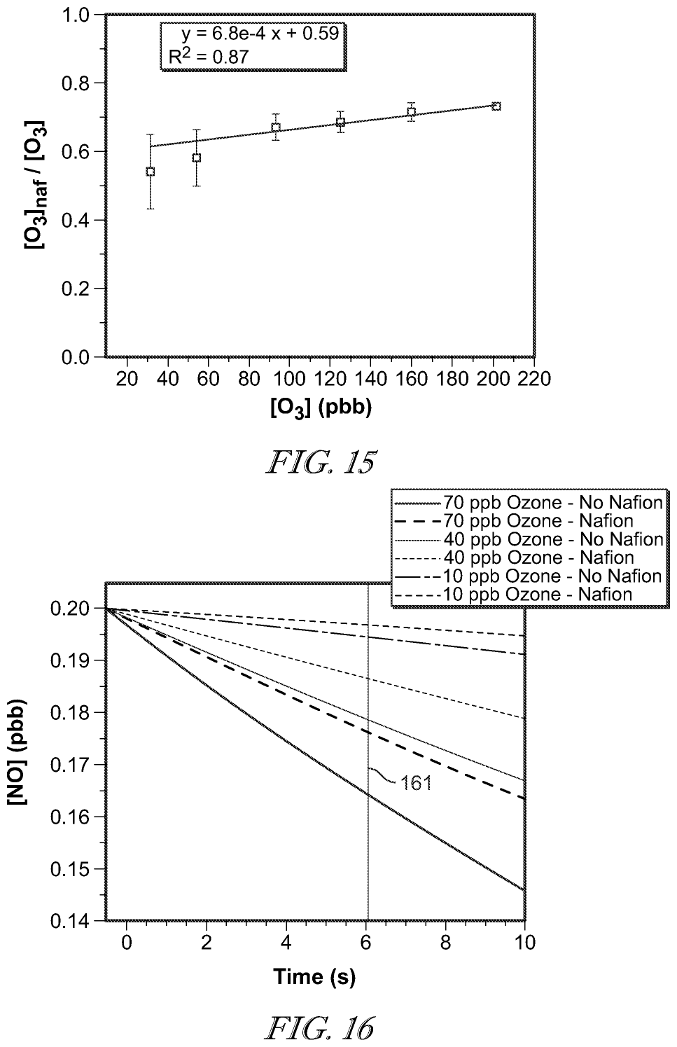

To test whether O₃ interacted with the Nafion™ reactor 12, the concentration of ozone in air mixtures (30-200 ppb) via UV absorption before and after they were flowed through the Nafion™ reactor 12 was measured. As shown in FIG. 15, between 30-50% of O, is lost to the Nafion™ reactor 12, with greater losses at the lower ozone concentrations. This is contrary to results previously reported for O₃ loss on Nafion™ in experiments which specifically tested Nafion™ dryers having far less surface area than the Nafion™ reactors 12 of the present disclosure.

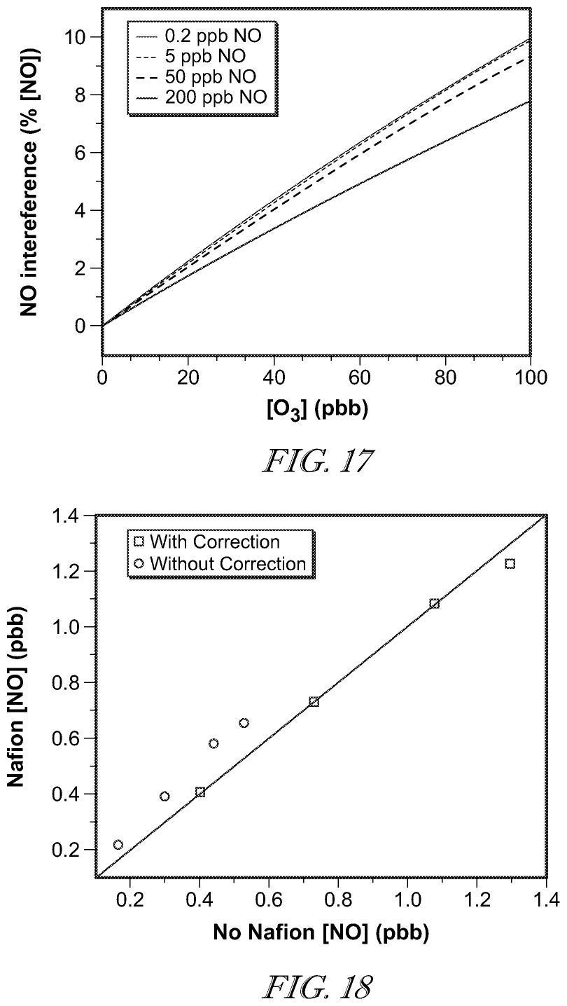

Total sample residence time from inlet 117, 121 to detector cell 113 was 6.1 s, as determined by modeling the NO signal drop when adding a high concentration of O₃ to the inlet 117. The modeled decrease in NO seen at the detector cell 113 with an inlet concentration of 0.2 ppb NO for three different inlet concentrations of O₃ (10, 40, and 70 ppb) is shown in FIG. 16. The vertical line 161 of FIG. 16 represents the sample residence time in the present instrument 100. The difference between the solid and dashed lines for 70 ppb indicates what would be reported as HONO by the present instrument 100 without correction, e.g. for 70 ppb of O, and 0.2 ppb NO, an extra 12 ppt of HONO would be erroneously measured. This effect is more pronounced for higher concentrations of both NO and O, though there is a non-linear dependence on the two. FIG. 17 shows the effects of this interference for the present instrument's residence time and four different NO mixing ratios (0.2, 5, 50, and 200 ppb) over a range of O₃ mixing ratios (0-100 ppb). For a given ozone concentration, the magnitude of the interference decreases as the concentration of NO increases. At 40 ppb of ozone, a typical indoor concentration, a 3-4% interference is possible, depending on the measured NO concentration. This interference grows in magnitude at higher O₃ concentrations.

FIG. 18 shows how correcting for this interference affects the accuracy of the measured data. This experiment involved generating a high concentration of O₃ (330 ppb) and flowing various concentrations of NO from a standardized tank through a reactor 12. Without the correction (red) the reported NO concentrations ranged from 0.2-0.6 ppb. Additionally, the NO signal was a factor of 1.7 higher when the sample flowed through the Nafion™ reactor 12; this signal would be reported as HONO. With the correction, shown in circles, NO concentrations ranged from 0.4 to 1.25 ppb and there was no statistical difference between the Nafion™ reactor 12 and blank tube pathway 125 (p<0.01). This experiment indicated that while O is not a direct interferent; it can alter NO concentrations in a way that would cause HONO to be overestimated if not corrected for. In general, the Nafion™ converter 12 may be highly selective for HONO.

### Example 10: Nafion™-CL and NI-PTR-CIMS Intercomparison

The selectivity and accuracy of the Nafion™-NOₓ-CL system 11 and method 13 for measuring HONO mixing ratios was tested by comparing measurements against the acetate ion NI-PTR-CIMS 129, which is a known method for measuring HONO. A flow of 3.8 L/min air containing HONO (1-3.5 ppb) was established through a 2 L Teflon™ chamber. The chamber residence time was ˜0.5 seconds at this flow rate, which allowed for adequate mixing. Experiments were carried out at ambient temperature (21° C.) and pressure (770 torr); the chamber was covered with black felt cloth to prevent photolysis reactions. Data for each measurement was averaged every five minutes in accordance with the NOₓ-CL analyzer 100 measurement cycle. The measurements proceeded for 6 hours, generating 81 points for intercomparison.

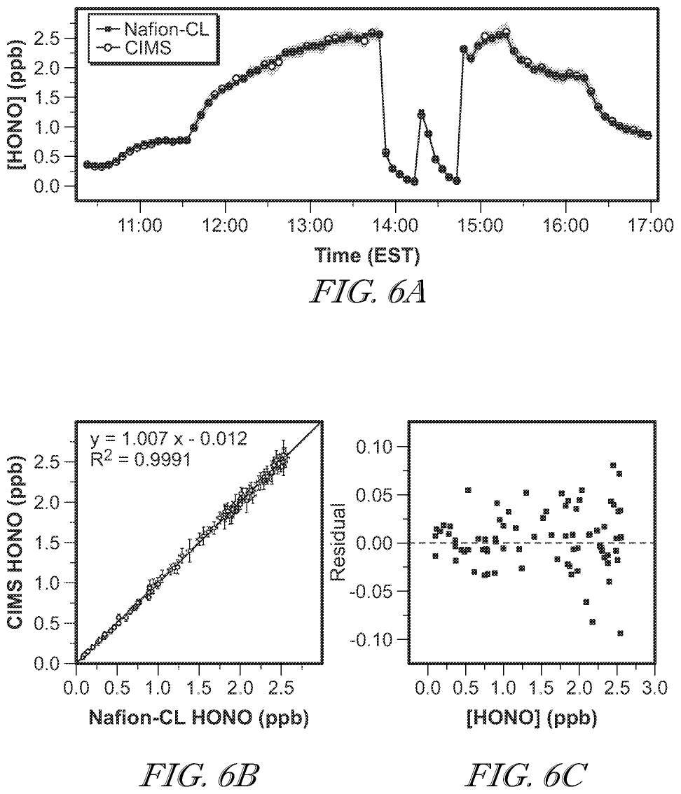

As shown in FIGS. 6A-C, there is a strong positive correlation between the HONO measured by Nafion™-NOₓ-CL system 11 and NI-PTR-CIMS 129 within the chamber (slope=1.007, intercept=−0.013, R²=0.9991). The mean relative standard error (RSE) of the NOₓ-CL analyzer 100 was lower (0.66%) than the NI-PTR-CIMS 129 (1.65%) over the range of tested concentrations, showing the Nafion™ reactor 12 displayed higher precision during the chamber experiments. Additionally, 96% of the HONO concentrations measured by the Nafion™-NOₓ-CL system 11 fell within to of those measured by the NI-PTR-CIMS 129; 100% of the Nafion™-CL HONO measurements fell within 2a of the NI-PTR-CIMS 129 measurements. The residuals showed a larger spread at high concentrations, suggesting more deviation was achieved in the measurement techniques.

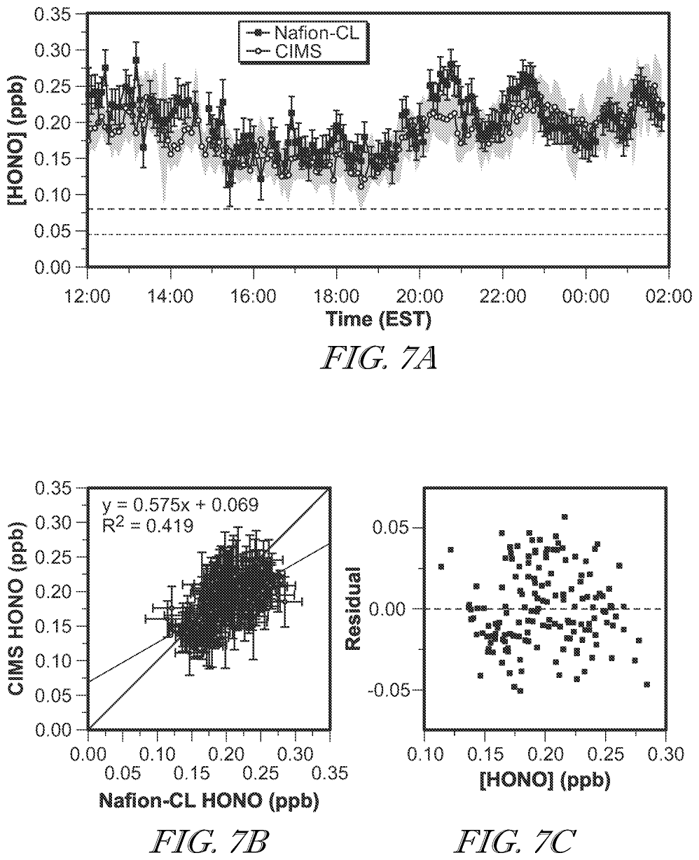

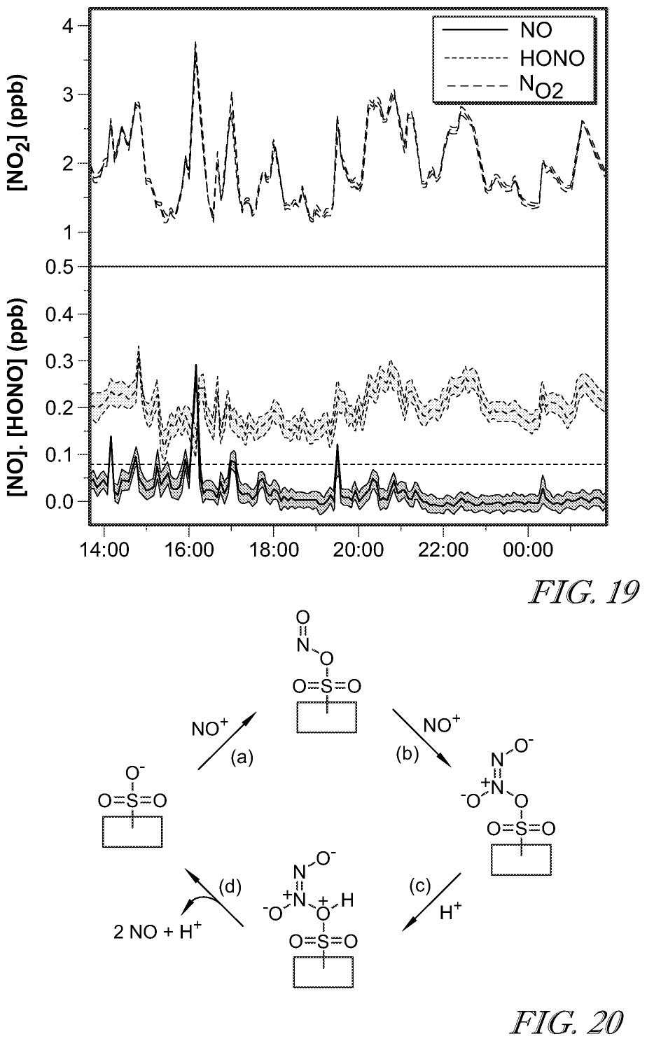

Following the chamber experiments, indoor (laboratory) air was sampled concurrently by the Nafion™-NOₓ-CL analyzer 11 and the NI-PTR-CIMS 129. The sample inlets 117, 121 for both instruments were co-located 10 cm apart and the room air was turbulent and well-mixed due to a high air exchange rate (40 h⁻¹). Measurements were performed over a 14 hour period, lasting from midday until the early morning of the next day. As shown in FIG. 19, the Nafion™-NOₓ-CL method 13 produced high precision measurements of NO, NO₂, and HONO during this measurement period. Results from the instrument intercomparison are shown in FIGS. 7A-C. Correlation between the Nafion™-NOₓ-CL analyzer 11 and NI-PTR-CIMS 129 was much weaker in this experiment compared to the chamber experiment (y=0.58 x+0.07, R²=0.41). Weaker correlations are due to the low variability of indoor air concentrations (clustered between 110-240 ppt) compared to the chamber experiment, which covered a wider range of HONO concentrations. Despite this, temporal trends in HONO concentrations were found to be identical for both the NI-PTR-CIMS and Nafion™-CL datasets. It was found that 63% of the Nafion™-CL measurements fell within 1a of the NI-PTR-CIMS measurements and 99% fell within 3σ of the NI-PTR-CIMS measurement. Thus, the majority of the Nafion™-CL measurements were within the random error of the NI-PTR-CIMS measurements. Additionally, the mean bias was small (−16 ppt) though the range of differences between was large (−99 ppt to 53 ppt). This may be explained by the distance between inlets, however there were periods where the Nafion™-NOₓ-CL analyzer 11 consistently measured greater (or less) HONO over a period that may not be explained by inlet distance alone (assuming adequately mixed air).

Additionally, the measurement discrepancies may be due to differences in the duty cycle of the single channel Nafion™-NOₓ-CL system 11 and NI-PTR-CIMS 129. Sequential measurements of NO, NO₂, and HONO made by Nafion™-NOₓ-CIL system 11 occur on a longer time scale than concentration fluctuations in room air, which are better tracked by the high frequency sampling of the NI-PTR-CIMS 129. This may lead to subtraction errors, resulting in over- or underestimations of HONO concentrations relative to the mass spectrometer. This may be remedied by having either a two-detector system 100 that cycles between NO₂ and HONO while constantly measuring NO, or a three-detector system 100 that continually monitors all three NO, species simultaneously. Regardless, the present intercomparison shows the accuracy and sensitivity of the Nafion™-NOₓ-CL method 13 in a stable simulated environment against an established method for HONO detection, and demonstrates the additional capability to measure sub-ppb levels of NO and NO₂.

The following numbered clauses are contemplated and non-limiting:

Clause 1: A system adapted to convert gaseous nitrous acid into gaseous nitric oxide, the system comprising a catalytic converter including a polytetrafluoroethylene tube and one or more concentric tubes positioned within the polytetrafluoroethylene tube, wherein the one or more concentric tubes comprise of sulfonated tetrafluoroethylene-based fluoropolymer-copolymer, and a nitric oxide analyzer including a gas inlet, wherein the catalytic converter is coupled to the gas inlet of the nitric oxide analyzer so that a flow of gas is pumped through the catalytic converter into the nitric oxide analyzer, and wherein the catalytic converter converts gaseous nitrous acid included in the flow of gas into nitric oxide, and wherein the nitric oxide analyzer detects the nitric oxide in the flow of gas.

Clause 2: The system of clause 1, any suitable clause, or any suitable combination of clauses, wherein the nitric oxide analyzer has a limit of detection for detecting nitric oxide, and the catalytic converter is adapted to measure nitrous acid concentrations of at least the limit of detection of the nitric oxide analyzer.

Clause 3: The system of clauses 1 and 2, any suitable clause, or any suitable combination of clauses, wherein the one or more concentric tubes includes at least five concentric tubes.

Clause 4: The system of clauses 1-3, any suitable clause, or any suitable combination of clauses, whcrcin the at lcast fivc conccntric tubcs dcfinc a surface area of sulfonated tetrafluoroethylene-based fluoropolymer-copolymer, the catalytic converter defines a volume, and a surface area-to-volume ratio is at least 25, depending on the flow requirements of the nitric oxide analyzer.

Clause 5: The system of clauses 1-4, any suitable clause, or any suitable combination of clauses, wherein the one or more concentric tubes includes six concentric tubes, and the surface area-to-volume ratio is at least 30, depending on the flow requirements of the nitric oxide analyzer.

Clause 6: The system of clauses 1-5, any suitable clause, or any suitable combination of clauses, wherein the surface area-to-volume ratio results in a conversion efficiency of at least 33%.

Clause 7: The system of clauses 1-6, any suitable clause, or any suitable combination of clauses, wherein the system further includes a perfluoroalkoxy alkane tube and a valve system coupled to the perfluoroalkoxy alkane tube and the catalytic converter to selectively direct the flow of gas through the catalytic converter or the perfluoroalkoxy alkane tube.

Clause 8: The system of clauses 1-7, any suitable clause, or any suitable combination of clauses, wherein nitric oxide is measurable through the perfluoroalkoxy alkane tube.

Clause 9: The system of clauses 1-8, any suitable clause, or any suitable combination of clauses, wherein the system further includes a temperature-controlled oven that maintains a predetermined operating temperature and requires an inlet flow of humidified air, and wherein the catalytic converter is located inside the temperature-controlled oven.

Clause 10: The system of clauses 1-9, any suitable clause, or any suitable combination of clauses, wherein the predetermined operating temperature is about 40° C.

Clause 11: A system adapted to convert gaseous nitrous acid into gaseous nitric oxide, the system comprising a catalytic converter including a polytetrafluoroethylene or glass tube and one or more glass substrates positioned within the polytetrafluoroethylene or glass tube, wherein the one or more glass substrates are coated in a sulfonated tetrafluoroethylene-based fluoropolymer-copolymer resin, and a nitric oxide analyzer including a gas inlet, wherein the catalytic converter is coupled to the gas inlet of the nitric oxide analyzer so that a flow of gas is pumped through the catalytic converter into the nitric oxide analyzer, and wherein the catalytic converter converts gaseous nitrous acid included in the flow of gas into nitric oxide, and wherein the nitric oxide analyzer detects the nitric oxide in the flow of gas.

Clause 12: The system of clause 11, any suitable clause, or any suitable combination of clauses, wherein the nitric oxide analyzer has a limit of detection for detecting nitric oxide, and the catalytic converter is adapted to measure nitrous acid concentrations of at least the limit of detection of the nitric oxide analyzer.

Clause 13: The system of clauses 11 and 12, any suitable clause, or any suitable combination of clauses, wherein the catalytic converter further includes polytetrafluoroethylene mesh positioned within the polytetrafluoroethylene or glass tube to hold the one or more glass substrates inside the polytetrafluoroethylene or glass tube.

Clause 14: The system of clauses 11-13, any suitable clause, or any suitable combination of clauses, wherein the one or more glass substrates comprise one or more of glass beads, glass fiber, glass capillaries, glass mesh, textured glass, glass or ceramic honeycomb substrate, or porous glass.

Clause 15: The system of clauses 11-14, any suitable clause, or any suitable combination of clauses, wherein the one or more glass substrates define a surface area of sulfonated tetrafluoroethylene-based fluoropolymer-copolymer, the catalytic converter defines a volume, and a surface area-to-volume ratio is at least 25, depending on the flow requirements of the nitric oxide analyzer.

Clause 16: The system of clause 11-15, any suitable clause, or any suitable combination of clauses, wherein the surface area-to-volume ratio results in a conversion efficiency of at least 33%.

Clause 17: The system of clauses 11-16, any suitable clause, or any suitable combination of clauses, wherein the system further includes a perfluoroalkoxy alkane tube and a valve system coupled to the perfluoroalkoxy alkane tube and the catalytic converter to selectively direct the flow of gas through the catalytic converter or the perfluoroalkoxy alkane tube.

Clause 18: The system of clauses 11-17, any suitable clause, or any suitable combination of clauses, wherein nitric oxide is measurable through the perfluoroalkoxy alkane tube.

Clause 19: The system of clauses 11-18, any suitable clause, or any suitably combination of clauses, wherein the system further includes a temperature-controlled oven that maintains a predetermined operating temperature and requires an inlet flow of humidified air, and wherein the catalytic converter is located inside the temperature-controlled oven.

Clause 20: The system of clauses 11-20, any suitable clause, or any suitable combination of clauses, wherein the predetermined operating temperature is about 40° C.

While the concepts of the present disclosure are susceptible to various modifications and alternative forms, specific exemplary embodiments of the disclosure have been shown by way of example in the drawings. It should be understood, however, that there is no intent to limit the concepts of the present disclosure to the particular disclosed forms; the intention is to cover all modifications, equivalents, and alternatives falling within the spirit and scope of the invention as defined by the claims. Although this disclosure refers to specific embodiments, it will be understood by those skilled in the art that various changes in form and detail may be made without departing from the subject matter set forth in the accompanying claims.

1. A system adapted to convert gaseous nitrous acid into gaseous nitric oxide, the system comprising:
a catalytic converter including a polytetrafluoroethylene tube and one or more concentric tubes positioned within the polytetrafluoroethylene tube, wherein the one or more concentric tubes comprise of sulfonated tetrafluoroethylene-based fluoropolymer-copolymer, and
a nitric oxide analyzer including a gas inlet,
wherein the catalytic converter is coupled to the gas inlet of the nitric oxide analyzer so that a flow of gas is pumped through the catalytic converter into the nitric oxide analyzer, and
wherein the catalytic converter converts the gaseous nitrous acid included in the flow of gas into nitric oxide, and wherein the nitric oxide analyzer detects the nitric oxide in the flow of gas.

2. The system of claim 1, wherein the nitric oxide analyzer has a limit of detection for detecting nitric oxide, and the catalytic converter is adapted to measure nitrous acid concentrations of at least the limit of detection of the nitric oxide analyzer.

3. The system of claim 1, wherein the one or more concentric tubes includes at least five concentric tubes.

4. The system of claim 3, wherein the at least five concentric tubes define a surface area of sulfonated tetrafluoroethylene-based fluoropolymer-copolymer, the catalytic converter defines a volume, and a surface area-to-volume ratio is at least 25, depending on the flow requirements of the nitric oxide analyzer.

5. The system of claim 4, wherein the one or more concentric tubes includes six concentric tubes, and the surface area-to-volume ratio is at least 30, depending on the flow requirements of the nitric oxide analyzer.

6. The system of claim 4, wherein the surface area-to-volume ratio results in a conversion efficiency of at least 33%.

7. The system of claim 1, wherein the system further includes a perfluoroalkoxy alkane tube and a valve system coupled to the perfluoroalkoxy alkane tube and the catalytic converter to selectively direct the flow of gas through the catalytic converter or the perfluoroalkoxy alkane tube.

8. The system of claim 7, wherein the nitric oxide is measurable through the perfluoroalkoxy alkane tube.

9. The system of claim 1, wherein the system further includes a temperature-controlled oven that maintains a predetermined operating temperature and requires an inlet flow of humidified air, and wherein the catalytic converter is located inside the temperature-controlled oven.

10. The system of claim 9, wherein the predetermined operating temperature is about 40° C.

11. A system adapted to convert gaseous nitrous acid into gaseous nitric oxide, the system comprising:
a catalytic converter including a polytetrafluoroethylene or glass tube and one or more glass substrates positioned within the polytetrafluoroethylene or glass tube, wherein the one or more glass substrates are coated in a sulfonated tetrafluoroethylene-based fluoropolymer-copolymer resin, and
a nitric oxide analyzer including a gas inlet,
wherein the catalytic converter is coupled to the gas inlet of the nitric oxide analyzer so that a flow of gas is pumped through the catalytic converter into the nitric oxide analyzer, and
wherein the catalytic converter converts the gaseous nitrous acid included in the flow of gas into nitric oxide, and wherein the nitric oxide analyzer detects the nitric oxide in the flow of gas.

12. The system of claim 11, wherein the nitric oxide analyzer has a limit of detection for detecting nitric oxide, and the catalytic converter is adapted to measure nitrous acid concentrations of at least the limit of detection of the nitric oxide analyzer.

13. The system of claim 11, wherein the catalytic converter further includes polytetrafluoroethylene mesh positioned within the polytetrafluoroethylene or glass tube to hold the one or more glass substrates inside the polytetrafluoroethylene or glass tube.

14. The system of claim 11, wherein the one or more glass substrates comprise one or more of glass beads, glass capillaries, glass fiber, glass mesh, textured glass, glass or ceramic honeycomb substrate, or porous glass.

15. The system of claim 11, wherein the one or more glass substrates define a surface area of sulfonated tetrafluoroethylene-based fluoropolymer-copolymer, the catalytic converter defines a volume, and a surface area-to-volume ratio is at least 25, depending on the flow requirements of the nitric oxide analyzer.

16. The system of claim 15, wherein the surface area-to-volume ratio results in a conversion efficiency of at least 33%.

17. The system of claim 11, wherein the system further includes a perfluoroalkoxy alkane tube and a valve system coupled to the perfluoroalkoxy alkane tube and the catalytic converter to selectively direct the flow of gas through the catalytic converter or the perfluoroalkoxy alkane tube.

18. The system of claim 17, wherein the nitric oxide is measurable through the perfluoroalkoxy alkane tube.

19. The system of claim 11, wherein the system further includes a temperature-controlled oven that maintains a predetermined operating temperature and requires an inlet flow of humidified air, and wherein the catalytic converter is located inside the temperature-controlled oven.

20. The system of claim 19, wherein the predetermined operating temperature is about 40° C.
